(19) United States
(12) Patent Application Publication
(10) Pub. No.: US 2019/0096187 A1
(43) Pub. Date: Mar. 28, 2019

(54) GAME DEVICE AND GAME CONTROL METHOD

(71) Applicant: SEGA SAMMY CREATION INC., Tokyo (JP)

(72) Inventor: Shunichi Fujita, Tokyo (JP)

(21) Appl. No.: 16/082,121

(22) PCT Filed: Mar. 4, 2016
(86) PCT No.: PCT/JP2016/056825

§ 371 Date: Sep. 4, 2018

(51) Int. Cl. G07F 17/32

(52) U.S. Cl. CPC G07F 17/3267; G07F 17/3209; G07F 17/3213

(57) ABSTRACT

A game device comprises a control unit and a display unit. The control unit modifies a display on the display unit during a first game by displaying some of a plurality of symbols comprising a first symbol sequentially on the display unit, and stops modifying the display at a predetermined timing. When the first symbol is displayed, the control unit modifies the display on the display unit during a second game by displaying some of a plurality of symbols while displaying a second symbol in a display position in which the first symbol is displayed, and stops modifying the display at a predetermined timing. When the display position of the first symbol and the display position of the second symbol during the second game have a predetermined positional relationship, the control unit grants an award, thereby providing a more entertaining game.

### CROSS-REFERENCE TO RELATED APPLICATIONS

This application is the U.S. national phase of the International Patent Application No. PCT/JP2016/056825 filed Mar. 4, 2016, the entire content of which is incorporated herein by reference.

### TECHNICAL FIELD

The present disclosure relates to a game device and a game control method.

### BACKGROUND

In recent years, various game devices have been developed. For example, Japanese Patent Publication JP 2015-024139 A discloses a game device that allows a slot game to be played by displaying parts of virtual reels on a display unit and spinning the reels under the control of a computer. In this type of slot game, the game device spins a plurality of reels in response to an operation performed by a player, stops the reels in sequence, and displays a combination of symbols depicted on the reels on the display unit. The game device then grants the player an award on the basis of the displayed combination of symbols. For example, when five identical symbols are arranged consecutively, a higher award is granted to the player than when three identical symbols are arranged consecutively. Further, depending on the symbols displayed on the stopped reels, an award may not be granted.

The player then starts the next game by spinning the reels, whereupon an award is granted in accordance with the combination of symbols displayed on the stopped reels.

### SUMMARY

The entertainment level of the game is of primary concern to the player, and the entertainment level of the game varies greatly depending on the conditions on which awards are granted.

The present disclosure has been designed in consideration of the circumstances described above, and an object thereof is to provide a technique for obtaining a more entertaining game.

A game device according to the present disclosure comprises a control unit, the control unit having a function in which a display on a display unit is modified during a first game by displaying some of a plurality of symbols comprising a first symbol sequentially on the display unit, and modification of the display is stopped at a predetermined timing, a function in which, when the first symbol is displayed after modification of the display is stopped during the first game, the display on the display unit is modified during a second game by displaying some of a plurality of symbols comprising the first symbol sequentially on the display unit while displaying a second symbol in a display position in which the first symbol is displayed when modification of the display is stopped during the first game, and modification of the display is stopped at a predetermined timing, and a function in which an award is granted when the display position of the first symbol and the display position of the second symbol during the second game have a predetermined positional relationship.

Another game device according to the present disclosure comprises a control unit, the control unit having a function in which a display on a display unit is modified during a first game by displaying some of a plurality of symbols comprising a first symbol sequentially on the display unit, and modification of the display is stopped at a predetermined timing, a function in which, when the first symbol is displayed after modification of the display is stopped during the first game, the display on the display unit is modified during a second game by displaying some of the plurality of symbols sequentially on the display unit while prominently displaying a display position in which the first symbol is displayed after modification of the display is stopped during the first game, and modification of the display is stopped at a predetermined timing, and a function in which an award is granted when the display position of the first symbol during the first game and the display position of the first symbol during the second game have a predetermined positional relationship.

A game control method according to the present disclosure is implemented in a game device comprising a control unit, and comprises a step in which the control unit modifies a display on a display unit during a first game by displaying some of a plurality of symbols comprising a first symbol sequentially on the display unit, and stops modifying the display at a predetermined timing, a step in which, when the first symbol is displayed after modification of the display is stopped during the first game, the control unit modifies the display on the display unit during a second game by displaying some of a plurality of symbols comprising a second symbol, instead of the first symbol, sequentially on the display unit, and stops modifying the display at a predetermined timing, and a step in which the control unit grants an award when a stopping position of the first symbol during the first game and a stopping position of the second symbol during the second game have a predetermined positional relationship.

Another game control method according to the present disclosure is implemented in a game device comprising a control unit, and comprises a step in which the control unit modifies a display on the display unit during a first game by displaying some of a plurality of symbols comprising a first symbol sequentially on the display unit, and stops modifying the display at a predetermined timing, a step in which, when the first symbol is displayed after modification of the display is stopped during the first game, the control unit modifies the display on the display unit during a second game by displaying some of the plurality of symbols sequentially on the display unit while prominently displaying a display position in which the first symbol is displayed after modification of the display is stopped during the first game, and stops modifying the display at a predetermined timing, and a step in which the control unit grants an award when the display position of the first symbol during the first game and the display position of the first symbol during the second game have a predetermined positional relationship.

According to the present disclosure, a technique for obtaining a more entertaining game can be provided.

### BRIEF DESCRIPTION OF THE DRAWINGS

Various embodiments of the disclosure are illustrated in the drawings, in which:

FIG. 1 is a perspective view showing an outer appearance of a game device according to an embodiment.

FIG. 2 is a block diagram showing a main hardware configuration of the game device according to this embodiment.

FIG. 3 is a conceptual diagram showing an example of a screen displayed on a display device according to this embodiment.

FIG. 4 is a block diagram showing a main functional configuration of the game device according to this embodiment.

FIG. 5 is a conceptual diagram showing an example of a screen displayed on the display device according to this embodiment.

FIG. 6 is a flowchart illustrating processing executed by the game device according to this embodiment.

FIG. 7 is a conceptual diagram showing an example of a screen displayed on the display device according to this embodiment.

FIG. 8 is a conceptual diagram showing examples of graphics displayed on the display device according to this embodiment.

### DETAILED DESCRIPTION

An embodiment of the present disclosure will be described below with reference to the figures. Note, however, that the embodiment described below is merely an example, and does not exclude the application of various amendments and techniques not described explicitly below. In other words, the present disclosure may be implemented after undergoing various amendments (combinations of embodiments and so on) within a scope that does not depart from the spirit thereof. Further, in the following description of the figures, identical or similar parts have been allocated identical or similar reference numerals. The figures are schematic, and do not necessarily reflect actual dimensions, ratios, and so on. Among the figures, parts having different dimensional relationships and ratios may also be included.

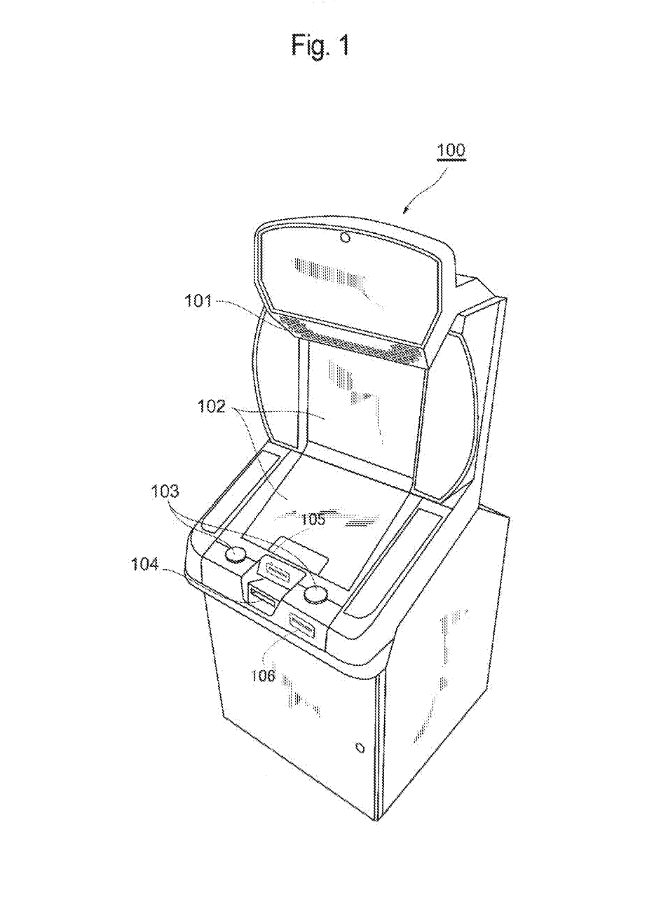

A game device and a program according to an embodiment of the present disclosure will be described below using the figures. FIG. 1 is a perspective view showing an outer appearance of the game device according to this embodiment.

A game device 100 shown in FIG. 1 is a game device disposed in a casino, an amusement facility, or the like. In this embodiment, a player can play a slot game using the game device 100.

Example of Hardware Configuration of Game Device

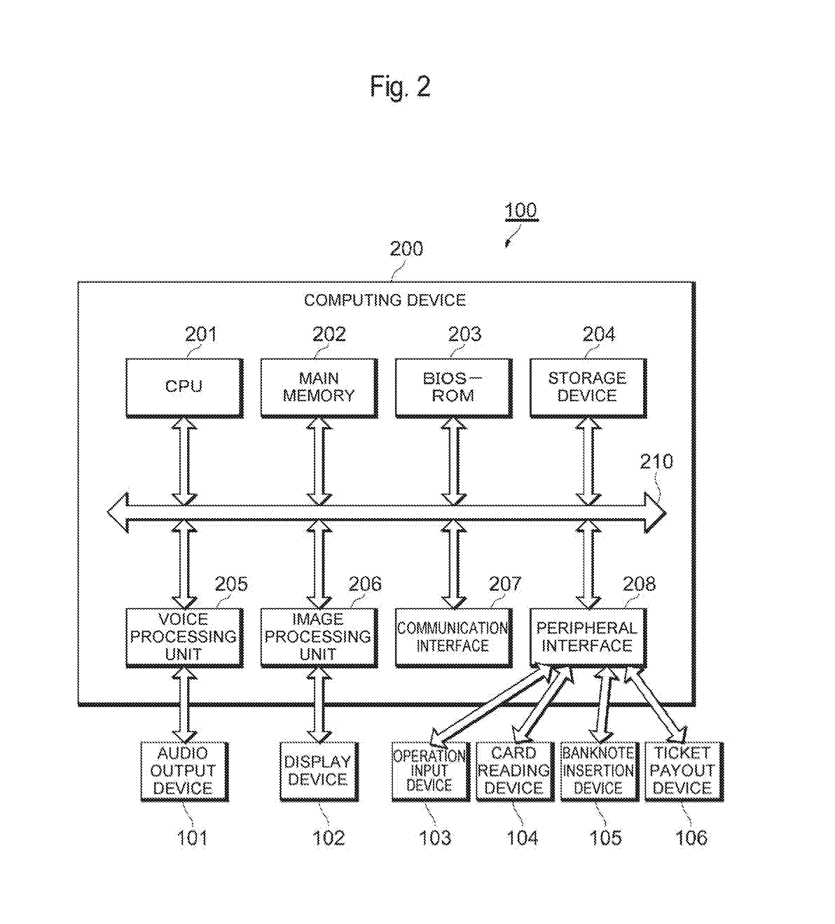

Referring to FIGS. 1 and 2, an example of a hardware configuration of the game device 100 will be described. As shown in FIG. 1, the game device 100 comprises, on the exterior thereof, a speaker 101, a plurality of display devices 102, a plurality of operating buttons (referred to hereafter as an “operation input device” 103), a card reading device 104, a banknote insertion device 105, and a ticket payout device 106. The speaker 101 serves as acoustic output means for outputting voice guidance, sound effects, and so on in relation to the game. The display device 102 is constituted by an upper-lower pair of display devices, and displays images (static images, moving images, video, and so on, for example) representing or dramatizing the game. The operation input device 103 is constituted by a plurality of buttons, and the buttons are used to input instructions from the player into the game device. Note that the operation input device 103 is not limited to this configuration, and may be configured as desired as long as the player can input instructions thereon. The card reading device 104 is a card reader that reads information from a card owned by the player. The banknote insertion device 105 is a device for reading an inserted banknote or ticket. The ticket payout device 106 serves as ticket outputting means for paying out cards to the player.

The card read by the card reading device 104 is a medium storing game information relating to the player. For example, points or the like that are procured in accordance with the game state of the player can be added to and stored on the card. The player can obtain various services in accordance with the information stored on the card, although the stored content of the card does not affect the game result.

As shown in FIG. 2, the game device 100 comprises, as a hardware configuration, a computing device 200, an audio output device 101, the display device 102, the operation input device 103, the card reading device 104, the banknote insertion device 105, and the ticket payout device 106.

The computing device 200 is a control device for implementing overall control of the game device 100. The computing device 200 is a computer circuit element constituted by various processors, memories, and so on, and comprising a chipset, for example. The computing device 200 according to this embodiment comprises, for example, a CPU 201, a main memory 202, a BIOS-ROM 203, a storage device 204, a voice processing unit 205, an image processing unit 206, a communication interface 207, a peripheral interface 208, and a system bus 210 for connecting these components.

The CPU 201 causes the computing device 200 to realize various functions by executing a game program expanded on the main memory 202, for example. In other words, the computing device 200 realizes the game in cooperation with other hardware by executing the game program under the control of the CPU 201.

The storage device 204 stores various programs and data as data required in the processing executed by the computing device 200 and results of the processing. The voice processing unit 205 executes various types of sound processing under the control of the CPU 201. The image processing unit 206 executes various types of graphics processing under the control of the CPU 201. The communication interface 207 is an interface that enables communication with a server or another game device. The peripheral interface 208 is an interface that enables communication with peripheral devices such as the operation input device 103, the card reading device 104, the banknote insertion device 105, and the ticket payout device 106.

Example of Game Content

Next, an example of the content of a game that can be played by a user using the game device 100 according to this embodiment will be described. The game is realized by having the game device 100 expand and execute the game program stored in the storage device 204 or the like on the main memory 202 under the control of the CPU 201 in order to control the various configurations of the game device 100.

First, the player starts the game by inserting the card owned thereby into the card reading device 104 of the game device 100 and/or inserting a coin into the banknote insertion device 105. Once the card or coin has been inserted, the player can possess a card balance or an amount of credit corresponding to the coin in the game.

Next, the game device 100 displays a betting screen allowing the player to bet on the slot game on the display device 102. The game device 100 then starts the slot game in response to a bet placed by the player and a start instruction issued thereby. A game that can be played by inserting a coin or the like in this manner so that the player is charged for the game will be referred to in the following description as a “normal game”. In contrast, a game that can be played free of charge so that the player is not charged for the game will be referred to as a “free game”. In the normal game or the free game, first, the game device 100 rotates a plurality of virtual reels (five reels, for example; hereafter, the virtual reels will be referred to simply as “reels”), and stops rotating each of the reels at a random timing. After the reels are stopped, the display device 102 displays a part of each reel.

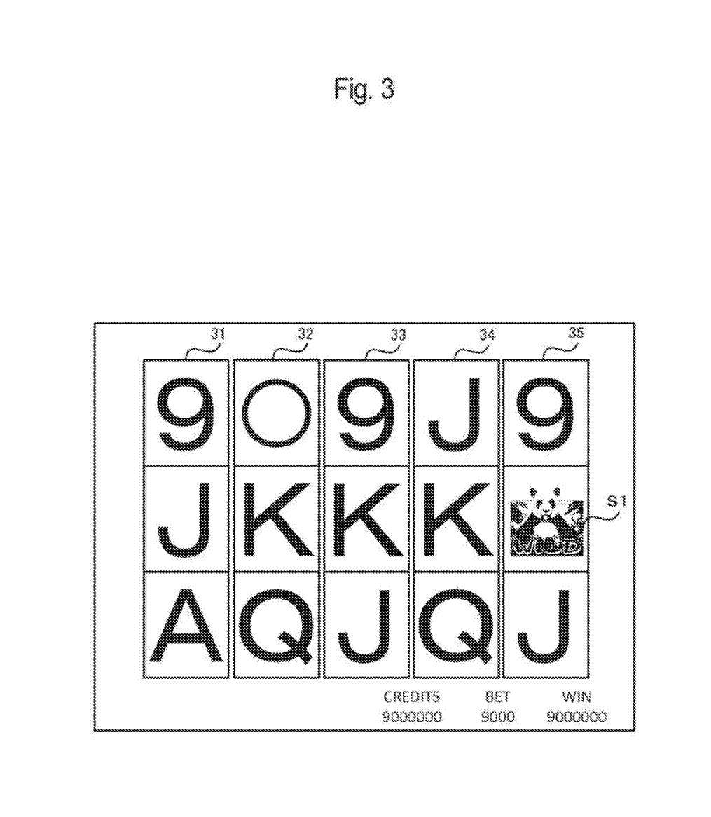

FIG. 3 shows an example of a display on the display device 102, in which symbols (pictures) depicted on parts of the respective reels are displayed after rotation of the reels is stopped. In this example, reels 31 to 35 are displayed, and three of the symbols depicted on each reel are displayed on the display device 102. The player is granted various awards depending on whether or not the symbols displayed on the display device 102 in this manner are arranged along a line (a pay line) set (or selected) in advance. The player is also granted various awards when a predetermined symbol (a “Wild” symbol, for example) is positioned in accordance with a predetermined condition (examples of conditions will be described below). There are no particular limitations on the awards, but examples thereof include credit and a free game. Further, awards of various values, from a big win to a small win, are set in accordance with the arrangement of the displayed symbols. For example, the size of the win may be set to increase, and a correspondingly higher amount of credit may be awarded, as the probability of an arrangement of uniform symbols appearing along the pay line decreases. The free game will be described further below.

The game device 100 shifts to a state in which a free game can be played when, for example, a predetermined symbol is displayed uniformly along the pay line (when three uniform symbols are arranged horizontally, for example) after rotation of the reels is stopped during a normal game. As a result, the player can play a predetermined number of free games (ten, for example) consecutively. Likewise during the free game, the player is granted various awards, such as credit or a retrigger, depending on the arrangement of the symbols and the position of a predetermined symbol after rotation of the reels is stopped. Here, a retrigger is an award allowing the player to play a predetermined number of additional free games (ten, for example). A method of granting awards during a free game will be described in detail below.

When all of the free games have been played, the game device 100 shifts back to a state in which the normal game can be played. Note that a period extending from a point at which the player becomes able to place a bet or issue a start instruction to a point at which a determination as to whether or not to grant an award is made in accordance with the stopping positions of the reels is defined as a single game unit. Once the determination as to whether or not to grant an award has been made during a first game, the player can bet on or issue a start instruction in relation to a second game following the first game.

Example of Functional Configuration of Game Device

Next, an example of a functional configuration of the game device 100 according to this embodiment will be described.

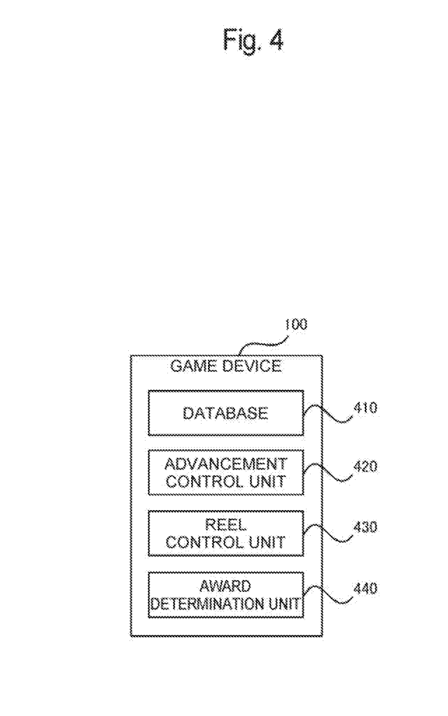

FIG. 4 is a functional block diagram illustrating the functional configuration of the game device 100 according to this embodiment in blocks. As shown in the figure, the game device 100 mainly comprises, as functional configurations, a database 410, an advancement control unit 420, a reel control unit 430, and an award determination unit 440. These functional configurations are realized by cooperation between the program (software) and the hardware of the game device 100 by, for example, having the CPU 201 expand and execute the game program stored in the storage device 204 on the main memory 202. Note that the game device 100 comprises other, typical functions of a game device in addition to the functions shown in FIG. 4, but description thereof has been omitted here.

The database 410 stores various types of information, such as information required for the processing executed in the game device 100 and information generated by the processing. For example, the database 410 stores a control program for controlling the advancement of the game, image (static image, moving image, video, and so on, for example) data and sound data used to represent or dramatize the game, data relating to the state of a game currently underway, and so on.

The advancement control unit 420 executes processing to control the advancement of the game in accordance with operations implemented by the player of the game on the game device 100 and the control program stored in the database 410. More specifically, the advancement control unit 420 executes control to advance a normal slot game, as described above, control to switch from the normal game to a free game, control to advance the free game, and control to switch from the free game to a normal game. For example, when a predetermined symbol is displayed uniformly (when three uniform symbols are arranged horizontally, for example) after rotation of the reels is stopped during a normal game, the advancement control unit 420 executes control to switch to a state in which a free game can be played. The advancement control unit 420 then implements control to execute a predetermined number of free games (ten, for example) consecutively. Further, the advancement control unit 420 executes the control described above in accordance with processing results obtained by the reel control unit 430 and the award determination unit 440, to be described below.

The reel control unit 430 controls spinning and stopping of the reels and display of a video of the reels on the display device 102 during the slot game. Images of a plurality of symbols are depicted on the surface of each reel, and the reel control unit 430 executes control such that some of the plurality of symbols are displayed on the display device 102. When the reels are spun, the reel control unit 430 executes control such that of the plurality of symbols depicted on each reel, symbols depicted in positions corresponding to the spin are displayed on the display device 102 while scrolling down sequentially, and at a predetermined timing, scrolling of the display is stopped. In the example shown in FIG. 3, the reel control unit 430 controls the spinning and stopping of each of five reels.

The reel control unit 430 can also execute control such that the symbols depicted on the reels in a certain game differ at least partially from the symbols depicted on the reels in another game. For example, the reel control unit 430 has a following control function.

First, in a first game, in accordance with a spin, the reel control unit 430 displays some of a plurality of symbols comprising a first symbol on the display device 102 so that the symbols scroll down sequentially. At a predetermined timing, the reel control unit 430 stops spinning the reels, whereby the scrolling display of the symbols is stopped.

Next, when the first symbol is displayed on the display device 102 after scrolling is stopped during the first game, during a second game following the first game, the reel control unit 430 spins reels depicting a plurality of symbols comprising a second symbol instead of the first symbol. In accordance with this spin, the reel control unit 430 displays some of the plurality of symbols comprising the second symbol on the display device 102 so that the symbols scroll down sequentially. At a predetermined timing, the reel control unit 430 stops spinning the reels, whereby the scrolling display of the symbols can be stopped.

Further, in the above example, when the first symbol is displayed on the display device 102 after scrolling of the displayed symbols is stopped during the first game, the reel control unit 430 can indicate the stopping position of the first symbol during the second game.

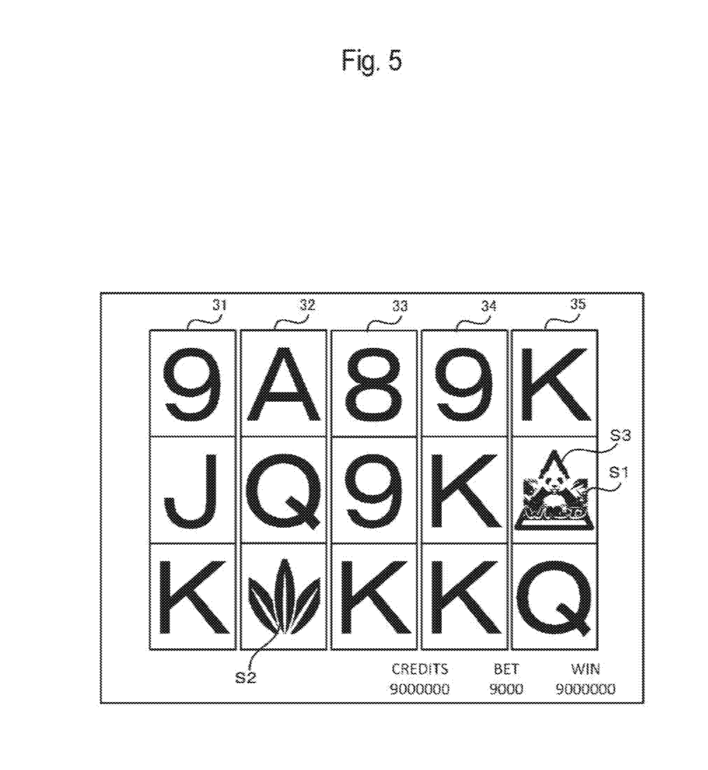

Referring to FIGS. 3 and 5, an example of a method of indicating the stopping position of the first symbol during the second game when the first symbol is displayed on the display device 102 after scrolling of the displayed symbols is stopped during the first game, as described above, will be described.

FIG. 3 shows a screen displayed on the display device 102 when scrolling is stopped during the first game. Further, a symbol S1 denotes the first symbol. FIG. 5 shows an example of a screen displayed on the display device 102 at the start of the second game (or at the point where the reels are spun) when the first game ends in the state shown in FIG. 3. In FIG. 5, the symbol S1 (the first symbol) is displayed on a symbol S3 displayed in the stopping position of the symbol S1 during the first game. In other words, the stopping position of the first symbol during the first game is indicated by the first symbol during the second game. Note that in order to indicate the stopping position of the first symbol during the first game, the first symbol may be displayed transparently, caused to flash, reduced in size, or altered in form during the second game.

Further, in FIG. 5, a symbol S2 denotes the second symbol. As described above, the second symbol is the symbol depicted on the reels in place of the first symbol during the second game when the first symbol is displayed on the display device 102 after scrolling of the displayed symbols is stopped during the first game.

Returning to FIG. 4, the award determination unit 440 determines the award in accordance with the arrangement of the symbols displayed on the display device 102 after scrolling of the displayed symbols (spinning of the reels) is stopped, and grants the award to the player. For example, the award determination unit 440 can determine the award to be granted according to whether or not the symbols are arranged along a line (a pay line) set or selected in advance. There are no particular limitations on the awards, but examples thereof include credit, an increased dividend (an increase in the amount or the multiplying factor of the dividend), and the right to play a free game.

The award determination unit 440 can also determine the award to be granted depending on whether or not a predetermined symbol is disposed in accordance with a predetermined condition. For example, a condition based on the position of a predetermined symbol during the first game and the position of a predetermined symbol during the second game may be set as the predetermined condition. More specifically, the award determination unit 440 can grant the player an award when the stopping position of the first symbol during the first game and the stopping position of the second symbol during the second game have a predetermined positional relationship. For example, the award determination unit 440 may grant the player an award when the stopping position of the first symbol during the first game and the stopping position of the second symbol during the second game match (or are adjacent to each other).

The award determination unit 440 can also determine the award to be granted to the player depending on the respective types of the first symbol and the second symbol having the predetermined positional relationship described above. For example, it is assumed that a symbol A, a symbol B, and a symbol C correspond to the first symbol, while a symbol D, a symbol E, and a symbol F correspond to the second symbol. At this time, the award is determined according to the symbols, among the symbols A to F, constituting the first symbol and the second symbol having the predetermined positional relationship.

According to this embodiment, as described above, when the first symbol is displayed after scrolling is stopped during the first game, some of a plurality of symbols comprising the second symbol instead of the first symbol are displayed while scrolling down sequentially during the second game following the first game, and at a predetermined timing, scrolling of the display is stopped. When the stopping position of the first symbol during the first game and the stopping position of the second symbol during the second game have a predetermined positional relationship, the player is granted an award.

Hence, in comparison with a conventional case, in which the player is granted an award only in accordance with the positional relationship between the symbols displayed after the reels are stopped during a single game, a more entertaining game can be realized. More specifically, the player hopes the first symbol will be displayed after the reels are stopped during the first game, and when the first symbol is displayed during the first game, the player hopes that the second symbol will be displayed after the reels are stopped during the second game. Accordingly, the sense of anticipation of an award experienced by the player can be increased in stages over a plurality of games. As a result, a more entertaining game can be realized.

Processing Flow

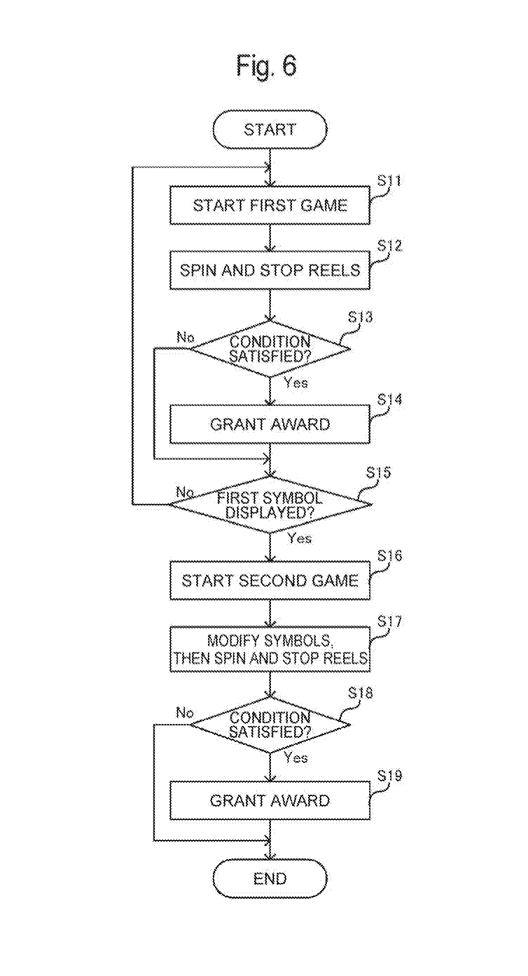

Next, referring to FIG. 6, a flow of the processing executed by the game device 100 will be described. This processing is executed by cooperation between the program (software) and the hardware of the game device 100 by, for example, having the CPU 201 function as a control unit that expands and executes the program stored in the storage device 204 or the like on the main memory 202, and so on. Note that the order of the respective processing steps included in the processing flow described below may be modified as desired, or the processing steps may be executed in parallel, as long as no inconsistencies occur in the processing content. Also, other steps may be added between the processing steps. Moreover, a step described for convenience as a single step may be executed after being divided into a plurality of steps, while steps described for convenience as a plurality of steps may be considered as a single step. Also note that the processing involved in the respective processing steps has already been described in detail, and therefore detailed description thereof has been omitted here.

First, in step S11, the CPU 201 starts to execute the first game of the slot game when the player inserts a payment for the game and issues an operation instruction on the game device 100, and then advances the game, whereupon the processing advances to step S12. Note that the first game may be a normal game or a free game. When the first game is a free game, a payment is not required to start the game. This applies likewise to the second game, to be described below.

In step S12, the CPU 201 executes control to display a video on the display device 102 showing the plurality of reels (five reels, for example) being spun and the spin being stopped at a predetermined timing. A plurality of symbols comprising the first symbol are depicted on each reel. As the reels are spun, the CPU 201 executes control to display the symbols depicted in positions corresponding to the spin, among the plurality of symbols depicted on the reels, on the display device 102 so that the symbols scroll down sequentially, and to stop scrolling of the display at a predetermined timing. The processing then advances to step S13.

In step S13, the CPU 201 determines whether or not the arrangement of the symbols displayed on the display device 102 after scrolling of the displayed symbols (spinning of the reels) is stopped satisfies a preset condition for granting an award (for example, whether or not a plurality of symbols are arranged along a pay line set or selected in advance). When the condition is satisfied (Yes), the processing advances to step S14, and when the condition is not satisfied (No), the processing advances to step S15.

In step S14, the CPU 201 grants the player an award corresponding to the condition determined to be satisfied in step S13. Credit or the right to play a free game, for example, is granted as the award. The processing then advances to step S15.

In step S15, the CPU 201 determines whether or not the first symbol is displayed on the display device 102 after scrolling is stopped during the first game. When the first symbol is displayed (Yes), the processing advances to step S16, and when the first symbol is not displayed (No), the processing advances to step S11.

In step S16, the CPU 201 starts to execute the second game of the slot game in response to an operation instruction issued by the player on the game device 100 or the like, whereupon the processing advances to step S17.

In step S17, the CPU 201 spins reels depicting a plurality of symbols that include the second symbol in place of the first symbol depicted on the reels of the first game. In accordance with the spin, the CPU 201 displays some of the plurality of symbols comprising the second symbol on the display device 102 so that the symbols scroll down sequentially. The CPU 201 then stops scrolling of the displayed symbols by stopping spinning the reels at a predetermined timing, whereupon the processing advances to step S18.

In step S18, the CPU 201 determines whether or not the arrangement of the symbols displayed on the display device 102 after scrolling of the displayed symbols (spinning of the reels) is stopped satisfies a preset condition for granting an award. This condition may include a condition based on the position of a predetermined symbol during the first game and the position of a predetermined symbol during the second game. More specifically, the condition may include a condition according to which the stopping position of the first symbol during the first game and the stopping position of the second symbol during the second game have a predetermined positional relationship (are in an identical position, for example). When the condition is satisfied (Yes), the processing advances to step S19, and when the condition is not satisfied (No), the processing of FIG. 6 is terminated.

In step S19, the CPU 201 grants the player an award corresponding to the condition determined to be satisfied in step S18. Credit or the right to play a free game, for example, is granted as the award. The processing of FIG. 6 is then terminated.

According to this embodiment, as described above, the player is granted an award when the stopping position of the first symbol during the first game and the stopping position of the second symbol during the second game have a predetermined positional relationship. Hence, in comparison with a conventional case, in which the player is granted an award only in accordance with the positional relationship between the symbols displayed after the reels are stopped during a single game, a more entertaining game can be realized. More specifically, the player hopes the first symbol will be displayed after the reels are stopped during the first game, and when the first symbol is displayed during the first game, the player hopes the second symbol will be displayed after the reels are stopped during the second game. Accordingly, the sense of anticipation of an award experienced by the player can be increased in stages over a plurality of games. As a result, a more entertaining game can be realized.

### MODIFIED EXAMPLES

The present disclosure is not limited to the embodiment described above, and may be implemented after adding various modifications thereto within a scope that does not depart from the spirit of the present disclosure. The above embodiment is in all respects merely an example, and is therefore not to be interpreted as limiting. For example, following modified examples may be employed.

### Modified Example 1

In the above embodiment, when the first symbol is displayed on the display device 102 after scrolling is stopped during the first game, the reel control unit 430 spins reels depicting a plurality of symbols comprising the second symbol instead of the first symbol in the second game following the first game. Further, in accordance with the spin, the reel control unit 430 displays some of the plurality of symbols comprising the second symbol on the display device 102 so that the symbols scroll down sequentially.

As a modified example of this processing, reels depicting a plurality of symbols comprising the first symbol may be spun likewise during the second game, similarly to the first game. More specifically, when the first symbol is displayed after scrolling is stopped during the first game, the reel control unit 430 displays, during the second game, some of the plurality of symbols comprising the first symbol on the display device 102 so that the symbols scroll down sequentially while prominently displaying the stopping position of the first symbol during the first game. The reel control unit 430 then stops scrolling of the display at a predetermined timing.

To display the stopping position of the first symbol prominently, a line surrounding the position in which the first symbol is displayed during the first game, for example, may be displayed on the display device 102. Moreover, the line may be displayed in an eye-catching color or shape, or caused to flash.

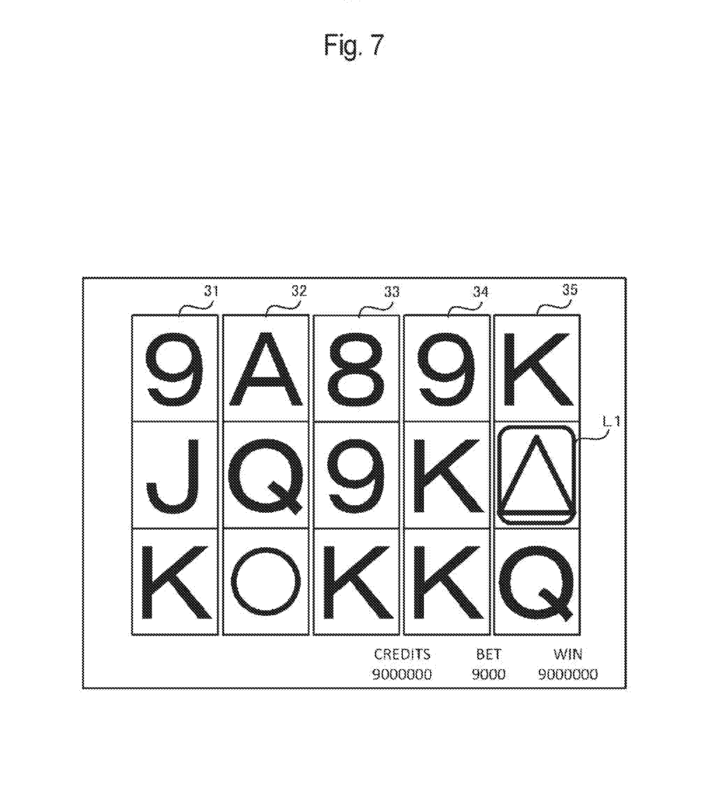

FIG. 7 shows an example of modified example 1, in which a line surrounding the position in which the first symbol is displayed during the first game is displayed on the display device 102. FIG. 7 shows an example of a screen displayed on the display device 102 at the start of the second game (or at the point where the reels are spun) when the first game ends in the state shown in FIG. 3. In FIG. 7, a line L1 surrounding the stopping position of the symbol S1 (the first symbol) during the first game is displayed.

In modified example 1, the award determination unit 440 grants the player an award when the stopping position of the first symbol during the first game and the stopping position of the first symbol during the second game have a predetermined positional relationship. For example, the award determination unit 440 can grant the player an award when the stopping position of the first symbol during the first game and the stopping position of the first symbol during the second game match (or are adjacent to each other).

### Modified Example 2

As a further modified example of modified example 1, when the first symbol is displayed after scrolling is stopped during the first game, during the second game, the reel control unit 430 can display some of a plurality of symbols comprising the first symbol on the display device 102 so that the symbols scroll down sequentially while displaying the second symbol in the stopping position of the first symbol during the first game. The reel control unit 430 can then stop scrolling of the display at a predetermined timing.

### Modified Example 3

When, during the second game, the first symbol (or a symbol corresponding to the first symbol; likewise hereafter in this modified example) stops in the stopping position of the first symbol during the first game, a symbol integrating the two symbols (an integrated graphic or a third symbol) can be displayed in the stopping position of the first symbol during the second game. Then, when the first symbol stops in the display position of the integrated graphic during a third game following the second game, a graphic further integrating the symbol with the integrated graphic can be displayed. The award determination unit 440 can grant the player an award of a steadily higher value as the number of integrated graphics (symbols) increases.

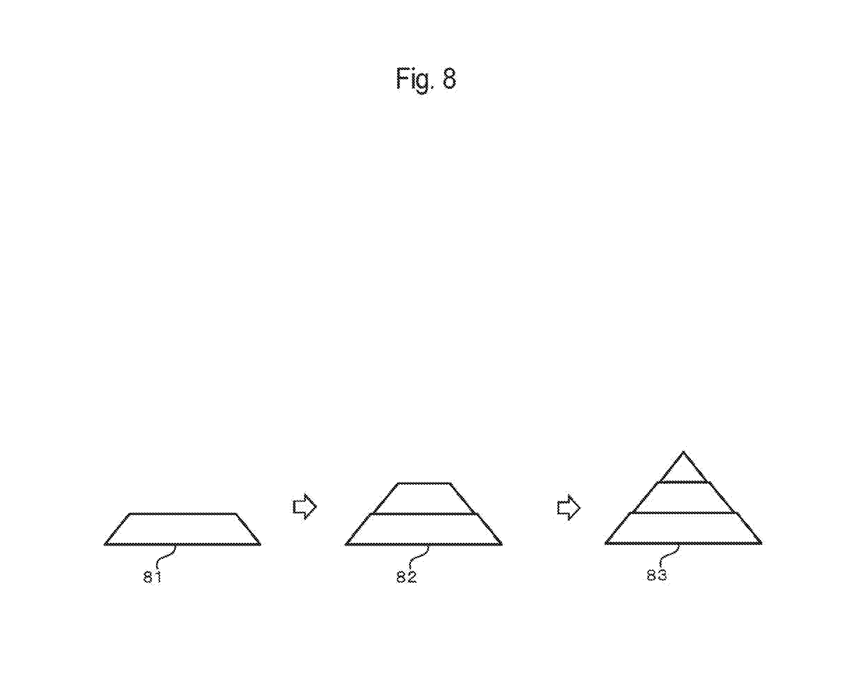

FIG. 8 shows examples of the integrated graphics used in modified example 3. A graphic 81 depicts the first symbol during the first game. A graphic 82 depicts an integrated graphic displayed when, during the second game, the first symbol is stopped in the stopping position of the first symbol during the first game. A graphic 83 depicts an integrated graphic displayed when, during the third game, the first symbol is stopped in the stopping position of the integrated graphic during the second game.

### LIST OF REFERENCE NUMERALS

100 Game device
101 Speaker
102 Display device
103 Operation input device
104 Card reading device
105 Banknote insertion device
106 Ticket payout device
201 CPU
202 Main memory
203 BIOS-ROM
204 Storage device
205 Voice processing unit
206 Image processing unit
207 Communication interface
208 Peripheral interface

1. A game device comprising a control unit and a display unit, the control unit having:
a function in which a display on the display unit is modified during a first game by displaying some of a plurality of symbols including a first symbol sequentially on the display unit, and modification of the display is stopped at a predetermined timing;
a function in which, when the first symbol is displayed after modification of the display is stopped during the first game, the display on the display unit is modified during a second game by displaying some of a plurality of symbols including the first symbol sequentially on the display unit while displaying a second symbol in a display position in which the first symbol is displayed when modification of the display is stopped during the first game, and modification of the display is stopped at a predetermined timing; and
a function in which an award is granted when the display position of the first symbol and the display position of the second symbol during the second game have a predetermined positional relationship.

2. A game device comprising a control unit and a display unit, the control unit having:
a function in which a display on the display unit is modified during a first game by displaying some of a plurality of symbols including a first symbol sequentially on the display unit, and modification of the display is stopped at a predetermined timing;
a function in which, when the first symbol is displayed after modification of the display is stopped during the first game, the display on the display unit is modified during a second game by displaying some of a plurality of symbols including a second symbol, instead of the first symbol, sequentially on the display unit, and modification of the display is stopped at a predetermined timing; and
a function in which an award is granted when a stopping position of the first symbol during the first game and a stopping position of the second symbol during the second game have a predetermined positional relationship.

3. The game device according to claim 2, wherein the control unit further has a function in which, when the first symbol is displayed after modification of the display is stopped during the first game, the stopping position of the first symbol is indicated during the second game.

4. The game device according to claim 1, wherein the award is determined according to respective types of the first symbol and the second symbol having the predetermined positional relationship.

5. The game device according to claim 1, wherein, when, as a result of the second game, the display position of the first symbol and the display position of the second symbol match, the control unit displays a third symbol in the display position and starts a following game while displaying the third symbol in the display position.

6. A game device comprising a control unit and a display unit, the control unit having:
a function in which a display on the display unit is modified during a first game by displaying some of a plurality of symbols including a first symbol sequentially on the display unit, and modification of the display is stopped at a predetermined timing;
a function in which, when the first symbol is displayed after modification of the display is stopped during the first game, the display on the display unit is modified during a second game by displaying some of the plurality of symbols sequentially on the display unit while prominently displaying a display position in which the first symbol is displayed after modification of the display is stopped during the first game, and modification of the display is stopped at a predetermined timing; and
a function in which an award is granted when the display position of the first symbol during the first game and the display position of the first symbol during the second game have a predetermined positional relationship.

7. The game device according to claim 6, wherein the prominent display includes displaying a line surrounding the position in which the first symbol is displayed during the first game.

8-9. (canceled)
